(19) United States
(12) Patent Application Publication
(10) Pub. No.: US 2007/0044772 A1
(43) Pub. Date: Mar. 1, 2007

(54) Fuel feed apparatus having electric connector

(75) Inventors: Yukio Sakamoto, Toyoake-city (JP); Takashi Akiba, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/491,017

(22) Filed: Jul. 24, 2006

(30) Foreign Application Priority Data
Aug. 26, 2005 (JP) 2005-245384

(51) Int. Cl. F02M 37/04

(52) U.S. Cl. 123/509

(57) ABSTRACT

A fuel feed apparatus is provided to a fuel tank. The fuel feed apparatus includes a lid member, a pump module, and an electric connector. The lid member plugs an opening of the fuel tank. The pump module is accommodated in the fuel tank for pumping fuel from the fuel tank. The electric connector is provided to the lid member. The electric connector includes at least one terminal and at least one sheath. The at least one terminal electrically connects with the pump module. The at least one sheath covers the at least one terminal partially on a side of the pump module. The at least one sheath has an outer periphery that is surrounded by a recess. The at least one sheath has an end on an opposite side of the pump module. The recess is concaved from the end of the at least one sheath toward the pump module.

### CROSS REFERENCE TO RELATED APPLICATIONS

This application is based on and incorporates herein by reference Japanese Patent Application No. 2005-245384 filed on Aug. 26, 2005.

### FIELD OF THE INVENTION

The present invention relates to a fuel feed apparatus including an electric connector.

### BACKGROUND OF THE INVENTION

According to JP-A-2002-237348, a connector for electrically connecting wirings has a structure adapted to restricting terminals from causing a shortcircuit therebetween. In this structure, the terminals are partitioned by a wall member, so that terminals adjacent to each other are restricted from causing a shortcircuit therebetween.

Here, a fuel feed apparatus is provided to a fuel tank for supplying fuel from the fuel tank to an engine outside the fuel tank. In general, when sealing property of a fuel tank provided with a fuel feed apparatus is examined, a submersion test is conducted while the fuel feed apparatus is installed on the fuel tank. In this submersion test, for example, the fuel tank installed with the fuel feed apparatus is submerged under water for examining the sealing property of the fuel tank. The fuel tank has an opening, which is plugged using a lid member of the fuel feed apparatus. The lid member may have an electric connector. When the submersion test is conducted, the electric connector provided to the lid member may be covered with a cap. After conducting the submersion test, air may be blown onto the electric connector to restrict water from remaining in the electric connector.

However, it is difficult to strictly restrict water from remaining in the connector, even providing the cap, and even blowing air onto the electric connector. In addition, when the electric connector is exposed to wind and weather after conducting the submersion test, water may intrude into the electric connector. When the electric connector is attached with a water-proof coupling device while water remains in the electric connector, the remaining water cannot be drained. As a result, terminals in the connector may be corroded. In addition, the terminals may cause shortcircuit therebetween.

### SUMMARY OF THE INVENTION

In view of the foregoing and other problems, it is an object of the present invention to produce a fuel feed apparatus including an electric connector with a simple structure having water-resistant property.

According to one aspect of the present invention, a fuel feed apparatus is provided to a fuel tank. The fuel feed apparatus includes a lid member that plugs an opening of the fuel tank. The fuel feed apparatus further includes a pump module that is accommodated in the fuel tank for pumping fuel in the fuel tank to an outside of the fuel tank. The fuel feed apparatus further includes an electric connector that is provided to the lid member. The electric connector includes at least one terminal and at least one sheath. The at least one terminal electrically connects with the pump module. The at least one sheath covers the at least one terminal partially on a side of the pump module. The at least one sheath has an outer periphery that is surrounded by a recess. The at least one sheath has an end on an opposite side of the pump module. The recess is concaved from the end of the at least one sheath toward the pump module.

Alternatively, a fuel feed apparatus is provided to a fuel tank. The fuel feed apparatus includes a lid member that plugs an opening of the fuel tank. The fuel feed apparatus further includes a pump module that is accommodated in the fuel tank for pumping fuel in the fuel tank to an outside of the fuel tank. The fuel feed apparatus further includes an electric connector that is provided to the lid member. The electric connector includes a terminal, a sheath, and an outer wall. The terminal electrically connects with the pump module. The sheath covers the terminal partially on a side of the pump module. The sheath extends toward an opposite side of the pump module. The outer wall extends toward the opposite side of the pump module. The outer wall and the sheath define a recess therebetween. The outer wall surrounds the sheath via the recess.

### BRIEF DESCRIPTION OF THE DRAWINGS

The above and other objects, features and advantages of the present invention will become more apparent from the following detailed description made with reference to the accompanying drawings. In the drawings:

FIG. 1 is a longitudinal view showing a fuel feed apparatus according to an embodiment;

FIG. 2 is a top view showing the fuel feed apparatus when being viewed from the arrow II in FIG. 1;

FIG. 3A is a top view showing an electric connector of the fuel feed apparatus, and FIG. 3B is a longitudinal sectional view taken along the line IIIB-IIIB in FIG. 3A; and

FIG. 4A is a longitudinal sectional view showing an electric connector, and FIG. 4B is a longitudinal view showing a sub-assembly of the electric connector, according to a modified embodiment.

### DETAILED DESCRIPTION OF PREFERRED EMBODIMENTS

### First Embodiment

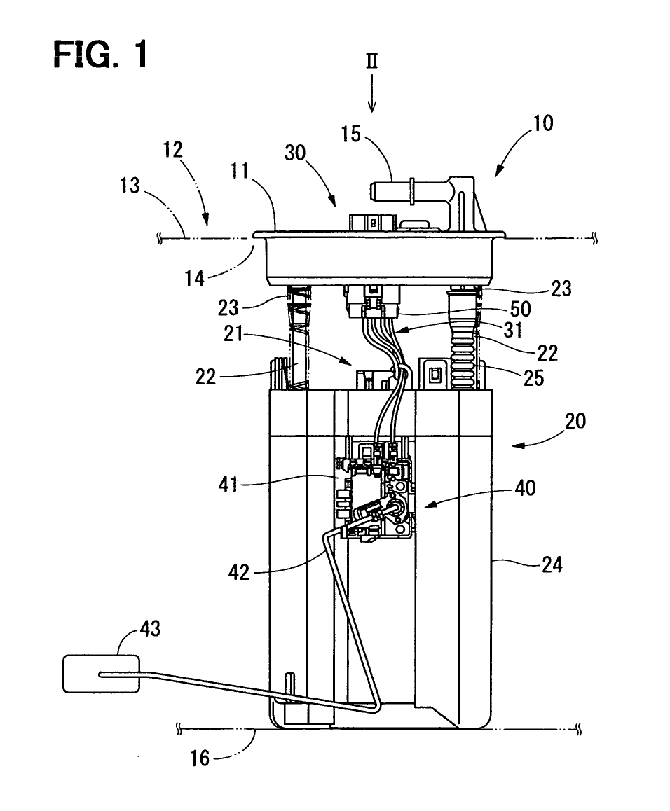

As shown in FIG. 1, a fuel feed apparatus 10 has a flange 11 serving as a lid member. The flange 11 is formed of resin to be in a substantially disc-shape, for example. The flange 11 is provided to an opening 14 formed in an upper wall 13 of a fuel tank 12. The flange 11 plugs the opening 14 in an installation work of the fuel feed apparatus 10 on the fuel tank 12. Components of the fuel feed apparatus 10 excluding the flange 11 are accommodated in the fuel tank 12. The fuel tank 12 is formed of resin, for example. The fuel feed apparatus 10 includes the flange 11 and a sub-tank 20. The flange 11 is attached to the fuel tank 12. The sub-tank 20 is accommodated in the fuel tank 12, as being supported by the flange 11. The sub-tank 20 accommodates the pump module 21.

The flange 11 includes an outlet pipe 15 and an electric connector 30. Fuel is discharged from a fuel pump (not shown) of the pump module 21. The outlet pipe 15 introduces the fuel discharged from the fuel pump to the outside of the fuel tank 12. The electric connector 30 connects with an electric power source and an electronic control unit (ECU: not shown). The electric connector 30 protrudes toward the sub-tank 20 through the flange 11. Lead wires 31 extend from the electric connector 30 into the fuel tank 12 through a coupler 50, which connects with the electric connector 30. The electric power source supplies electric power to the unillustrated fuel pump through the lead wires 31.

The flange 11 connects with the sub-tank 20 via a shaft 22, which serves as a supporting member. The shaft 22 is press-inserted into the flange 11 at one end, and is supported by the sub-tank 20 at the other end. The other end of the shaft 22 on the side of the sub-tank 20 is supported with respect to the sub-tank 20. The sub-tank 20 supports the shaft 22 such that the shaft 22 is axially movable with respect to the sub-tank 20. A spring 23 is provided around the outer periphery of the shaft 22. The spring 23 serves as a bias member. The spring 23 biases the flange 11 and the sub-tank 20 such that the flange 11 and the sub-tank 20 are spaced from each other. Thus, the flange 11 and the sub-tank 20, which accommodates the pump module 21, are movable relatively to each other substantially in the axial direction of the flange 11, i.e. in a vertical direction in FIG. 1. Consequently, the distance between the flange 11 and the sub-tank 20 is adjustable, so that the height of the fuel feed apparatus 10 can the adjusted. In this structure, the sub-tank 20 is regularly pressed onto a bottom wall 16 of the fuel tank 12 by bias force of the spring 23, even when the fuel tank 12 expands or shrinks due to variation in pressure in the fuel tank 12 caused by change in temperature and variation in an amount of fuel received in the fuel tank 12.

The sub-tank 20 has a sidewall 24. The outer periphery of the sidewall 24 is provided with a sender gauge 40. The sender gauge 40 is constructed of a detector 41, an arm 42, and a float 43. The sender gauge 40 detects the amount of fuel received in the fuel tank 12. The float 43 floats around the liquid surface, i.e., liquid level of fuel received in the fuel tank 12. The float 43 moves corresponding to the liquid level of fuel. The arm 42 supports the float 43 rotatably around the detector 41. The detector 41 has various electric wirings each having resistance different from each other. In this structure, the arm 42 supporting the float 43 rotates around the detector 41, as the float 43 moves corresponding to the liquid level of fuel. As the arm 42 rotates, a state of contact between the arm 42 and the detector 41 changes. Consequently, the resistance of the detector 41 changes corresponding to the liquid level of fuel. Thus, the liquid level of fuel is detected in accordance with the resistance of the detector 41. The detector 41 connects with the electric connector 30 via the lead wires 31. The sender gauge 40 detects the liquid level of fuel, and transmits the liquid level to an external device such as the ECU via the lead wires 31 and the electric connector 30.

The sub-tank 20 accommodates the pump module 21. The pump module 21 is constructed of the fuel pump, a fuel filter, a pressure regulator (not shown), and the like.

The fuel pump is driven using a motor (not shown), so that the fuel pump pressurizes fuel and discharges the pressurized fuel to the fuel filter. The fuel filter removes foreign matters contained in the discharged fuel. The pressure regulator controls pressure of the discharged fuel at predetermined pressure. The pressure regulator discharges the pressure-controlled fuel into the outlet pipe 15, provided to the flange 11, through the fuel pipe 25.

Next, the electric connector 30 is described in detail.

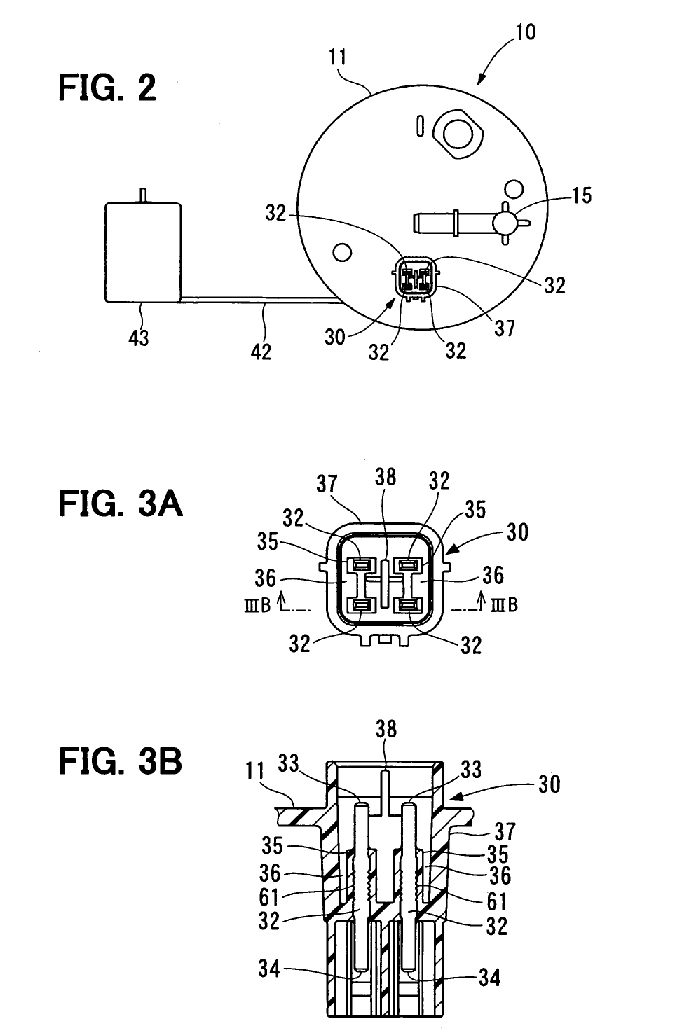

As shown in FIG. 2, the electric connector 30 is provided to the flange 11. The electric connector 30 is integrally formed of resin with the flange 11. As shown in FIGS. 3A, 3B, the electric connector 30 includes terminals 32. The terminals 32 are formed of conductive metal such as copper and aluminum. The terminals 32 penetrate the flange 11. In this structure, one end 33 of each of the terminals 32 is exposed from the flange 11 to the outside of the fuel tank 12. The other end 34 of each of the terminals 32 is exposed from the flange 11 into the fuel tank 12. The electric connector 30 is provided with a coupling device (not shown). The coupling device is attached to the electric connector 30 from the outside of the fuel tank 12, for example. The coupling device connects with the electric power source and the ECU at the end on the opposite side of the electric connector 30. The coupling device is connected to the electric connector 30, so that each of the terminals 32 electrically connects with a conductive member of the coupling device.

As referred to FIG. 1, the coupler 50 is connected to the electric connector 30 from the inside of the fuel tank 12. The lead wires 31 are electrically connected with the terminals 32 by connecting the coupler 50 with the electric connector 30. The end of the lead wires 31 on the opposite side of the electric connector 30 connects to the unillustrated fuel pump of the pump module 21 and the sender gauge 40.

As referred to FIGS. 3A, 3B, each of the terminals 32 has one axial end covered with a sheath 35. Each sheath 35 is integrally formed of resin with the flange 11, for example. The electric connector 30 has a recess 36 around each sheath 35. The recess 36 is defined between an outer wall 37 of the electric connector 30 and each sheath 35. The recess 36 is concaved from the end of each sheath 35 on the opposite side of the sub-tank 20 toward the pump module 21, i.e., toward the sub-tank 20. In this structure, the recess 36 surrounds the outer peripheries of the sheath 35. Specifically, each sheath 35 extends from the bottom of each sheath 35 toward the opposite side of the sub-tank 20 in the electric connector 30. The terminals 32 are exposed from the sheaths 35 on the opposite side of the sub-tank 20. In this structure, the recess 36 is defined between the outer wall 37 of the electric connector 30 and the sheaths 35.

The electric connector 30 includes a partition (inner wall) 38 that compartments the terminals 32 in the electric connector 30. The partition 38 connects with the sheaths 35 at one end, so that the partition 38 divides the interior of the electric connector 30 into multiple regions. In this structure, the partition 38 is located between the terminals 32 in the electric connector 30. Thus, the terminals 32 adjacent to each other can be restricted from causing a short circuit therebetween. The partition 38 is integrally formed of resin with the flange 11 and the electric connector 30, for example. The partition 38 supports the terminals 32, which protrude into the interior of the electric connector 30, together with the sheaths 35. In this structure, the terminals 32 and the sheaths 35 can be restricted from being inclined.

The terminals 32 are insert-molded in the electric connector 30 integrally with the flange 11, for example. That is, the terminals 32 are insert-molded as inserted members when the electric connector 30 and the flange 11 are molded. In this structure, the flange 11 can be readily formed with the electric connector 30, while a manufacturing work is restricted from being increased. Each of the terminals 32 has a ripple-shaped portion 61 at least partially midway through the axial direction of each terminal 32. The ripple-shaped portion 61 serves to enlarge a touch area between each terminal 32 and resin firmed to be the electric connector 30. In this structure, bonding force between each terminal 32, which serves as the inserted member, and resin, which is formed to be the flange 11 and the electric connector 30, can be enhanced.

The recess 36 is formed around the outer periphery of each sheaths 35 of each terminal 32, so that moisture and water intruding and remaining in the electric connector 30 can be accumulated in the recess 36. In this embodiment, the fuel feed apparatus 10 is installed in the fuel tank 12 such that the flange 11 is located on the upper side with respect to the direction of gravitational force. Therefore, moisture and water intruding and remaining in the electric connector 30 can be restricted from accumulating in the vicinity of the terminals 32 protruding from the sheaths 35, so that moisture and water may drop toward the recess 36 by gravitational force. Thus, the terminals 32 protruding from the sheaths 35 can be restricted from being adhered with moisture and water. Consequently, the terminals 32 can be restricted from being corroded due to moisture and water intruding into and accumulating in the electric connector 30. In addition, the terminals 32 can be restricted from causing shortcircuit therebetween via moisture and water adhering to the terminals 32. Thus, the water-resisting property of the electric connector 30 can be enhanced.

The recess 36 is formed around the outer periphery of the sheaths 35, so that the wall thickness of the electric connector 30 can be substantially uniformized from the end of the electric connector 30 on the opposite side of the sub-tank 20 to the side of the sub-tank 20. Therefore, the flange 11 and the electric connector 30 can be restricted from causing a recession, i.e., sink, after being formed of resin. Thus, the flange 11 and the electric connector 30 can be maintained in dimension through the forming process of the flange 11 and the electric connector 30, so that dimensional accuracy of the flange 11 and the electric connector 30 can be enhanced.

In this embodiment, the recess 36 is formed around the outer periphery of the sheaths 35 partially with respect to the axial direction of the terminals 32. The unillustrated coupling device connects with the electric connector 30 on the outside of the fuel tank 12 such that the unillustrated coupling device engages with the electric connector 30 on the opposite side of the sub-tank 20 with respect to the sheaths 35. Therefore, even the recess 36 is formed around the outer periphery of the sheaths 35, the recess 36 may not exert influence to the connection between the electric connector 30 and the unillustrated coupling device. In this structure, the locations of the terminals 32 need not be changed, even the recess 36 is formed. In addition, the sectional shape of the electric connector 30 need not be changed. Therefore, a conventional coupling device may be applied to the fuel feed apparatus 10, even the recess 36 is formed, so that compatibility can be maintained.

### Modified Embodiment

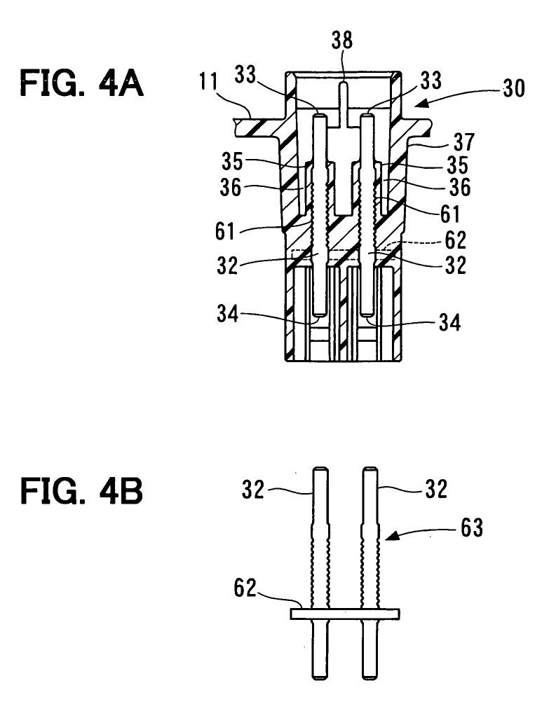

This modified embodiment is described in reference to FIGS. 4A, 4B. In the above embodiment, the terminals 32 are inserted in the electric connector 30 by insert-forming together with the flange 11. By contrast, as shown in FIGS. 4A, 4B, a sub-assembly 63 may be constructed of the terminals 32 and a resinous member (connecting member) 62 such that the terminals 32 are supported by the resinous member 62. The sub-assembly 63 may be insert-formed together with the flange 11 and the electric connector 30, as an inserted member. In this structure, the resin formed to be the resinous member 62 may be the same as the resin formed to be the flange 11 and the electric connector 30. Thus, in this structure, when resin is charged to form the flange 11 and the electric connector 30, the resinous member 62 of the sub-assembly 63 melts, so that the resinous member 62 is joined with the electric connector 30. Consequently, bonding force can be enhanced between the sub-assembly 63 and the resin formed to be the flange 11 and the electric connector 30.

The above structures of the embodiments can be combined as appropriate.

Various modifications and alternations may be diversely made to the above embodiments without departing from the spirit of the present invention.

What is claimed is:

1. A fuel feed apparatus provided to a fuel tank, the fuel feed apparatus comprising:
a lid member that plugs an opening of the fuel tank;
a pump module that is accommodated in the fuel tank for pumping fuel in the fuel tank to an outside of the fuel tank; and
an electric connector that is provided to the lid member,
wherein the electric connector includes at least one terminal and at least one sheath,
the at least one terminal electrically connects with the pump module,
the at least one sheath covers the at least one terminal partially on a side of the pump module,
the at least one sheath has an outer periphery that is surrounded by a recess,
the at least one sheath has an end on an opposite side of the pump module, and
the recess is concaved from the end of the at least one sheath toward the pump module.

2. The fuel feed apparatus according to claim 1, wherein the at least one sheath is formed of resin integrally with the lid member.

3. The fuel feed apparatus according to claim 1,
wherein the electric connector has an outer wall that surrounds the at least one sheath, and
the outer wall and the at least one sheath define the recess therebetween.

4. The fuel feed apparatus according to claim 3, wherein the outer wall has a thickness that is substantially uniform.

5. The fuel feed apparatus according to claim 1,
wherein the at least one terminal has a ripple-shaped portion at least partially midway through an axial direction of the at least one terminal,
the ripple-shaped portion is at least partially covered with the at least one sheath, and
the ripple-shaped portion has an outer periphery defining a plurality of grooves.

6. The fuel feed apparatus according to claim 1,
wherein the electric connector includes an inner wall that compartments the electric connector,
the at least one terminal includes a plurality of terminals, and
two of the plurality of terminals interpose the inner wall therebetween.

7. The fuel feed apparatus according to claim 6,
wherein the at least one sheath includes a plurality of sheaths,
the inner wall is integrally formed with the plurality of sheaths, and
the inner wall and the plurality of sheaths support the plurality of terminals.

8. The fuel feed apparatus according to claim 1,
wherein the at least one terminal includes a plurality of terminals,
the at least one sheath includes a plurality of sheaths,
the electric connector includes a sub-assembly that includes the plurality of terminals, the plurality of sheaths, and a connecting member,
the connecting member connects one of the plurality of sheaths with an other of the plurality of sheaths, and
the sub-assembly is at least partially embedded in the electric connector.

9. The fuel feed apparatus according to claim 1,
wherein the lid member is located on an upper side of the pump module with respect to a direction of gravitational force, and
the at least one terminal protruding from the at least one sheath upward with respect to the direction of gravitational force.

10. A fuel feed apparatus provided to a fuel tank, the fuel feed apparatus comprising:
a lid member that plugs an opening of the fuel tank;
a pump module that is accommodated in the fuel tank for pumping fuel in the fuel tank to an outside of the fuel tank; and
an electric connector that is provided to the lid member,
wherein the electric connector includes a terminal, a sheath, and an outer wall,
the terminal electrically connects with the pump module,
the sheath covers the terminal partially on a side of the pump module,
the sheath extends toward an opposite side of the pump module,
the outer wall extends toward the opposite side of the pump module,
the outer wall and the sheath define a recess therebetween, and
the outer wall surrounds the sheath via the recess.
